(19) United States
(12) Patent Application Publication
(10) Pub. No.: US 2005/0258736 A1
(43) Pub. Date: Nov. 24, 2005

(54) Display apparatus, its display module and display panel

(76) Inventors: Atsushi Kazama, Kashiwa (JP); Takeshi Terasaki, Mito (JP); Makoto Kitano, Tsuchiura (JP); Tatsuya Nagata, Ishioka (JP); Takashi Fujimura, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/133,305

(22) Filed: May 20, 2005

(30) Foreign Application Priority Data
May 21, 2004 (JP) 2004-151334

(51) Int. Cl. H01J 1/62; H01J 63/04

(52) U.S. Cl. 313/495; 313/497

(57) ABSTRACT

To achieve high resolution, lightening, and thinning in a display apparatus, the display apparatus includes a thin display panel and a control unit. The display panel includes an anode substrate, a cathode substrate forming an electron emitting chamber vacuously sealed between itself and the anode substrate, phosphors formed on the anode substrate, and a pressure support formed on the back of the electron emitting chamber side of the cathode substrate. The pressure support includes a vacuum seal member forming a pressure supporting chamber vacuously sealed between itself and the cathode substrate independently of the electron emitting chamber, and a reinforcement member which is formed of a member having a gap, which is sandwiched between the vacuum seal member and cathode substrate in the pressure supporting member, and at least both end portions of which span a bonding area of the cathode substrate for the anode substrate.

### CLAIM OF PRIORITY

The present application claims priority from Japanese application serial JP 2004-151334 filed on May 21, 2004, the content of which is hereby incorporated by reference into this application.

### FIELD OF THE INVENTION

The present invention relates to a display apparatus, its display module and display panel. Particularly, the present invention is appropriate for a field emission display apparatus.

### BACKGROUND OF THE INVENTION

A basic structure of a field emission display apparatus is described in, for example, the special feature “Basic knowledge of an electronic display for young engineers” in the April 2004 issue of a technical magazine “Electronic Material”, pages 94 to 102 (non-patent document 1). The field emission display apparatus is so structured that a cathode substrate on which many electron sources for emitting electrons are formed and an anode substrate to which phosphors are applied are placed opposite each other via a gap. Electrons emitted from the electron source corresponding to each pixel impinge on the phosphor to emit light, so that the field emission display apparatus displays images.

In the field emission display apparatus, the gap needs to be secured and vacuously sealed. In many cases, a plurality of thin spacers are set up between the anode substrate and cathode substrate to prevent the gap from collapsing due to the atmospheric pressure. However, the production, placement, and structure of the spacers which are thin enough not to be seen from the outside are difficult. Moreover, charge-up of the spacers causes turbulence of images. Therefore, a display panel structure requiring less or no spacers is desirable. It can be considered that an anode substrate and cathode substrate are made thick to decrease the flexing due to the atmospheric pressure. However, in a large screen pane over thirty-two inches, a display panel itself becomes very heavy. Patent documents relating to this are as follows.

Japanese Patent Laid-Open No. H3(1991)-236143 (patent document 1) discloses a conventional display apparatus. A vacuum vessel of this display apparatus includes a front plate formed of a transparent glass plate and a back plate formed of metal and having a box shape. Additionally, another back cover formed of metal and having a box shape is provided covering this back plate to make vacuous a space between the back plate and back cover, so that the lightening is achieved.

Japanese Patent Laid-Open No. H7(1995)-296746 (patent document 2) discloses a conventional image display apparatus. This image display apparatus includes a first envelope in which an image display member is disposed and a second envelope which covers the whole of the first envelope. The insides of both envelopes are made vacuous, so that the deformation of the first envelope due to the atmospheric pressure is prevented.

Further, Japanese Patent Laid-Open No. 2000-100355 (patent document 3) discloses a conventional display apparatus. In this display apparatus, a silicon substrate on which electron sources are formed is placed on a plane glass substrate on the electron source side, a glass substrate on the phosphor side is placed opposite the glass substrate on the electron source side, and a metal network is embedded in or attached to the glass substrate on the phosphor side. Accordingly, a strength of the glass substrate on the phosphor side is improved to achieve the thinning and lightening of the glass substrate on the phosphor side.
[Patent document 1] Japanese Patent Laid-Open No. H3(1991)-236143
[Patent document 2] Japanese Patent Laid-Open No. H7(1995)-296746
[Patent document 3] Japanese Patent Laid-Open No. 2000-100355
[Non-patent document 1] Special feature “Basic knowledge of an electronic display for young engineers” in the April 2004 issue of a technical magazine “Electronic Material”, pages 94 to 102

### SUMMARY OF THE INVENTION

However, in the display apparatus of the patent document 1, the back cover receiving the atmospheric pressure has a box shape similar to the back plate. Accordingly, although the deformation of the back plate can be prevented, the back cover needs to be made thick to withstand the atmospheric pressure. In this point, a problem about the lightening remains.

In the display apparatus of the patent document 2, the second envelope receiving the atmospheric pressure covers the whole of the first envelope. Accordingly, the deformation of the first envelope due to the atmospheric pressure can be prevented, but the second envelope needs to be made thick to withstand the atmospheric pressure. In this point, a problem about the lightening remains.

Further, in the display apparatus of the patent document 3, since the strength of the anode substrate is improved because of the embedding of the metal network, the anode substrate is hardly collapsed. However, a flexural rigidity of the anode substrate is not improved so much. Accordingly, when the anode substrate is made thin, its flexural rigidity is decreased to increase its flexing, so that an appropriate gap between the electron sources and phosphors cannot be maintained. The patent document 3 does not disclose how to thin and lighten the cathode substrate.

An object of the present invention is to provide a display apparatus, its display module and display panel in which high resolution, lightening, and thinning can be achieved.

To achieve the object of the present invention, a display apparatus having a thin display panel and a control unit for controlling the display panel includes: an anode substrate; a cathode substrate which is placed opposite the anode substrate and forms an electron emitting chamber vacuously sealed between the cathode substrate and the anode substrate; electron sources formed on the electron emitting chamber side of the cathode substrate; phosphors which are formed on the electron emitting chamber side of the anode substrate and receive electron beam from the electron sources to emit light; and a pressure support formed on the back of the electron emitting chamber side of the cathode substrate. The pressure support includes a vacuum seal member which forms a pressure supporting chamber vacuously sealed between the pressure support and the cathode substrate independently of the electron emitting chamber, and a reinforcement member which is formed of a member having a gap, which is sandwiched between the vacuum seal member and the cathode substrate in the pressure supporting chamber, and at least both end portions of which span a bonding area of the cathode substrate for the anode substrate. The control unit controls the electron sources.

A more preferable concrete structure is as follows.

(1) The reinforcement member is structured by use of any one of a honeycomb structure, a rib structure, a porous body, and a structure where a plurality of cloth fibers are laminated.

(2) The cathode substrate is formed thinner than the anode substrate. The vacuum seal member is formed thinner and lighter than the cathode substrate.

(3) In addition to (2), the vacuum seal member is formed of a flexible metal thin plate.

(4) A vacuum of the pressure supporting chamber is lower than that of the electron emitting chamber.

(5) The control unit is so structured that a substrate installing an IC is placed on a planar portion of the vacuum seal member.

(6) Many wirings for driving the electron sources formed on the cathode substrate are provided. The wirings are drawn from the electron sources to an outer area of the electron emitting chamber. The control unit is connected to the drawn portion of the wirings via a flexible wiring plate.

(7) The wirings are partially thinned on the bonding area for the anode substrate and cathode substrate.

(8) The cathode substrate has an evacuation port to evacuate the electron emitting chamber. The pressure support is placed on a portion except the evacuation port.

(9) In addition to (8), the cathode substrate is formed to be a quadrilateral, and has the evacuation port on its corner. The pressure support is formed by notching a portion corresponding to the evacuation port.

To achieve the object of the present invention, in a display module in which a thin display panel and a control unit for controlling the display panel are integrally combined, the display panel includes an anode substrate, a cathode substrate which is placed opposite the anode substrate and forms an electron emitting chamber vacuously sealed between the cathode substrate and the anode substrate, electron sources formed on the electron emitting chamber side of the cathode substrate, phosphors which are formed on the electron emitting chamber side of the anode substrate and receives electron beam from the electron sources to emit light, and a pressure support formed on the back of the electron emitting chamber side of the cathode substrate. The pressure support includes a vacuum seal member which forms a pressure supporting chamber vacuously sealed between the pressure support and the cathode substrate independently of the electron emitting chamber, and a reinforcement member which is formed of a member having a gap, which is sandwiched between the vacuum seal member and the cathode substrate in the pressure supporting chamber, and at least both end portions of which span a bonding area of the cathode substrate for the anode substrate. The control unit controls the electron sources.

To achieve the object of the present invention, a display panel includes an anode substrate, a cathode substrate which is placed opposite the anode substrate and forms an electron emitting chamber vacuously sealed between the cathode substrate and the anode substrate, electron sources formed on the electron emitting chamber side of the cathode substrate, phosphors which are formed on the electron emitting chamber side of the anode substrate and receive electron beam from the electron sources to emit light, and a pressure support formed on the back of the electron emitting chamber side of the cathode substrate. The pressure support includes a vacuum seal member which forms a pressure supporting chamber vacuously sealed between the pressure support and the cathode substrate independently of the electron emitting chamber, and a reinforcement member which is formed of a member having a gap, which is sandwiched between the vacuum seal member and the cathode substrate in the pressure supporting chamber, and at least both end portions of which span a bonding area of the cathode substrate for the anode substrate. The control unit controls the electron sources.

According to the present invention, by suppressing deformation of the cathode substrate by use of the pressure support, the display apparatus and its display module and display panel in which high resolution, lightening, and thinning can be achieved can be obtained.

### BRIEF DESCRIPTION OF THE DRAWINGS

FIG. 1 is an external perspective view of a display apparatus of a first embodiment of the present invention.

FIG. 2 is a cross sectional view of a display panel module of the first embodiment.

FIG. 3 is a cross sectional view of the display panel of the first embodiment.

FIG. 4 is a perspective view of the display panel of FIG. 3 which is partially cut.

FIG. 5 is a cross sectional view showing an alternative of a display panel of FIG. 3.

FIG. 6 is a perspective view showing a one quarter portion of a cathode substrate 4 of the first embodiment.

FIGS. 7A to 7C are enlarged cross sectional views of a drawn portion of wiring of FIG. 6.

FIG. 8 is a perspective view showing one example of a reinforcement member used in the first embodiment.

FIG. 9 is a perspective view showing an alternative of FIG. 8.

FIG. 10 is a perspective view showing another alternative of FIG. 8.

FIG. 11 is a plane view in a state that the cathode substrate and reinforcement member are laminated.

FIG. 12 shows an alternative of FIG. 11.

FIG. 13 is a cross sectional view showing a structure of a display panel in a second embodiment of the present invention.

FIG. 14 is a perspective view showing the display panel of FIG. 13 which is partially cut.

### DETAILED DESCRIPTION OF THE PREFERRED EMBODIMENTS

A plurality of embodiments of the present invention are explained below with reference to the figures. The same numeral in each figure shows the same component or the corresponding component.

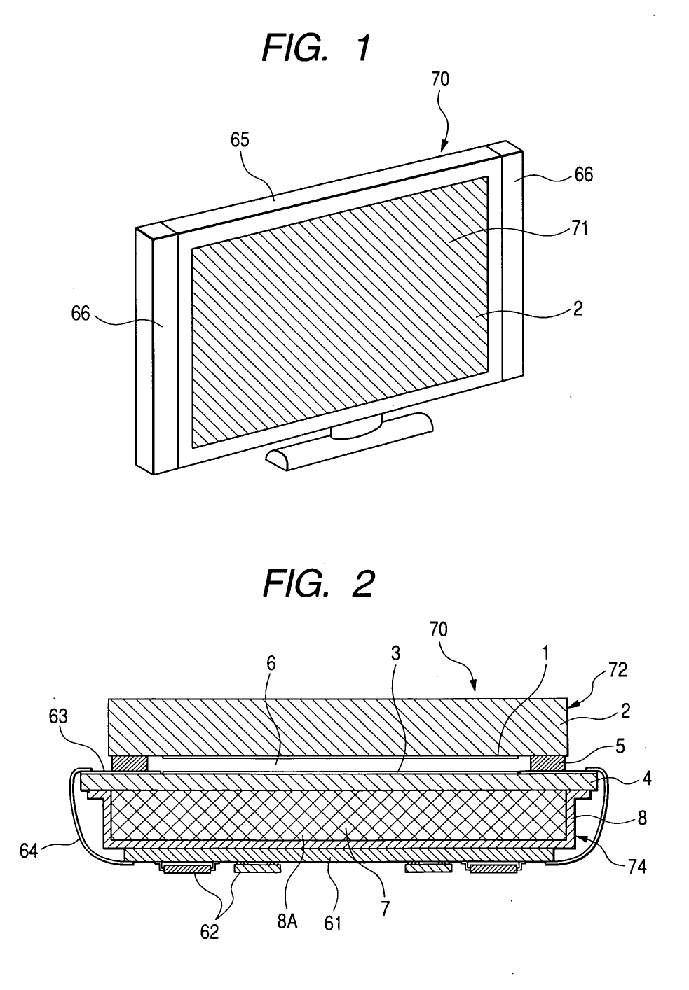

A display apparatus of a first embodiment of the present invention is explained with reference to FIGS. 1 to 13.

First, an overall structure of a display apparatus 70 of this embodiment is explained with reference to FIG. 1. FIG. 1 is an external perspective view of the display apparatus 70 of this embodiment.

This display apparatus 70 is an example applied to a television set, and includes a body 65, a display panel module 71, and speakers 66. The display apparatus of the present invention is applicable to a display apparatus for, e.g., a personal computer and DVD.

A display panel module 71 is thin and light, and mounted in the body 65. An anode substrate 2 of the display panel module 71 is exposed from a front window (shaded portion of FIG. 1) of the body 65 in a planar fashion. In this embodiment, the display panel module 71 is applicable to a panel having a screen over thirty-two inches. A transparent protection film is applied to a surface of the anode substrate 2, for example, to prevent damage of the anode substrate 2.

The body 65 is formed thin because of thinning of the display panel module 71. A power source, television tuner, control unit, and so on are stored in the body 65, and connected to the display panel module 71. The speakers 66 are mounted to, for example, both sides of the body 65.

Next, the display panel module 71 is explained with reference to FIG. 2. FIG. 2 is a cross sectional view of the display panel module 71 of this embodiment.

The display panel module 71 is structured by integrally combining the display panel 72 with the control unit 73, and can display images by converting image data introduced from the outside. Because of this modular integrally-combined display panel 72 and control unit 73, an ability verification and check for the display panel 72 can be executed when the module is independent, and the display apparatus 70 can be easily assembled.

The control unit 73 is so structured that integrated circuits 62 are mounted on a control board 61. The integrated circuits 62 are comprised of a microprocessor, an amplifier, a memory, and so on. Since the control unit 73 is placed on a planar portion of an outer surface of the vacuum seal member 8, the control unit 73 can be easily placed.

The electron sources 3 are connected to the control unit 73 via the wiring 63 and flexible wiring plate 64, and controlled by the control unit 73. The wiring 63 is formed on the cathode substrate 4. One side of the wiring 63 is connected to the electron sources 3 in the electron emitting chamber 6, and the other side is drawn to the outside of the electron emitting chamber 6. The wiring 63 drawn to the outside and wiring formed on the control board 61 are connected by the flexible wiring plate 64 to connect the electron sources 3 and control unit 73.

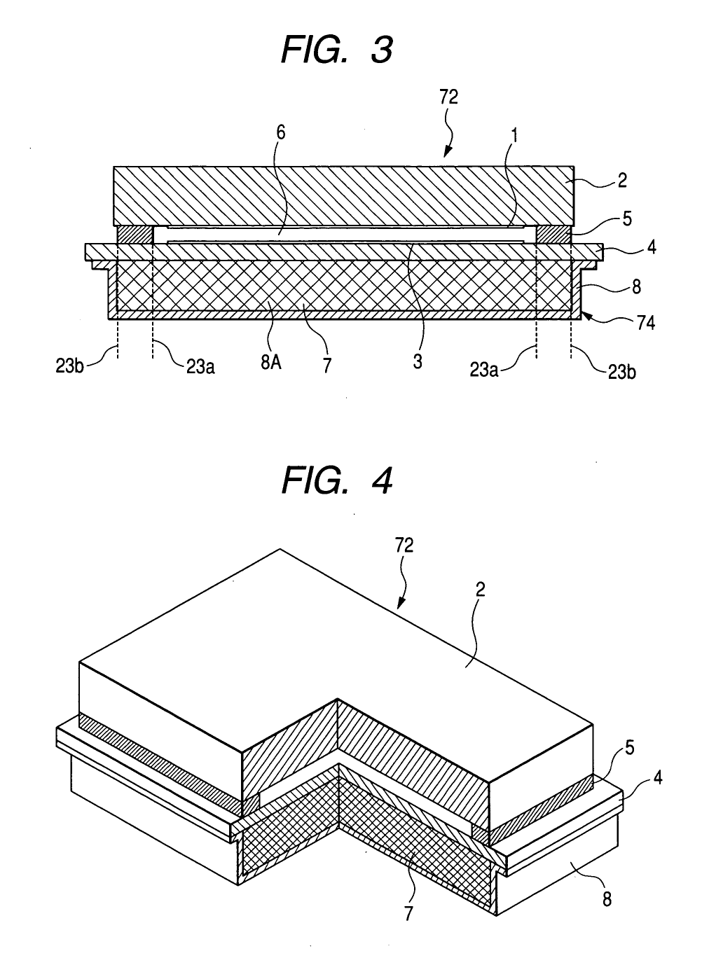

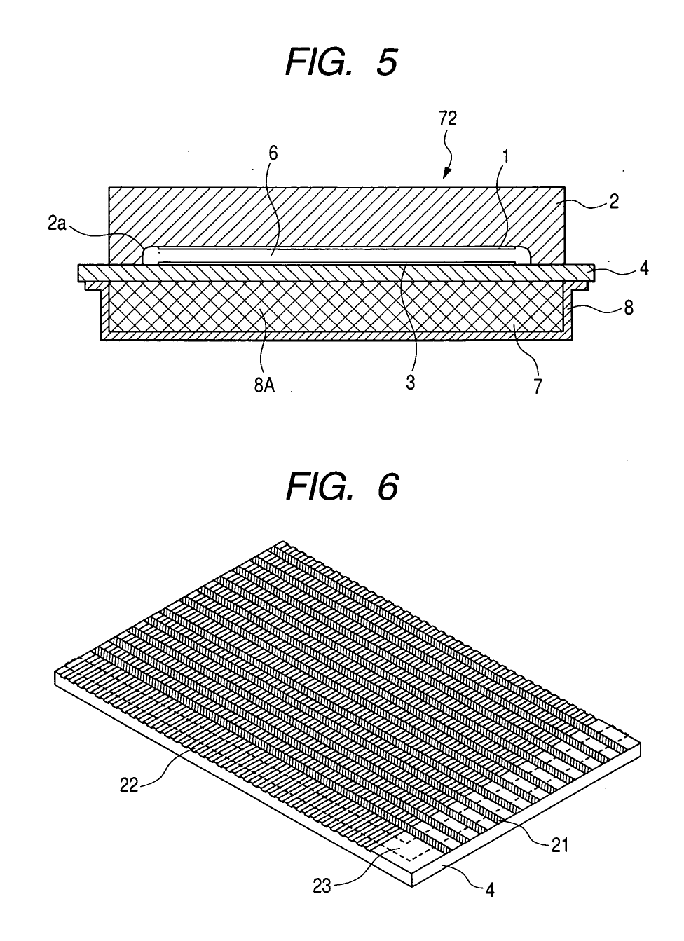

Next, the display panel 72 is explained with reference to FIGS. 3 to 5. FIG. 3 is a cross sectional view of the display panel 72 of this embodiment. FIG. 4 is a perspective view in a state that the display panel 72 is partially cut. FIG. 5 is a cross sectional view showing an alternative of the display panel 72 of FIG. 3. In FIGS. 3 to 5, the wiring formed on the surface of the cathode substrate 4 is not shown.

The display panel 72 includes an anode substrate 2, a planar cathode substrate 4 which is placed opposite the anode substrate and forms an electron emitting chamber 6 vacuously sealed between the cathode substrate 4 and the anode substrate 2, electron sources 3 formed on the electron emitting chamber side of the cathode substrate 4, phosphors 1 formed on the electron emitting chamber side of the anode substrate 2 and receive electron beam from the electron sources 3 to emit light, and a pressure support 74 formed on the back of the electron chamber side of the cathode substrate 4.

The anode substrate 2 is formed of a planar transparent glass whose surface is applied a film of the phosphors 1. The anode substrate 2 is formed to be a quadrilateral (more especially, rectangle). The cathode substrate 4 forms many electron sources 3 on its surface, and is formed in a planar fashion. The cathode substrate 4 is formed to be a quadrilateral (more especially, rectangle) rather larger than the anode substrate 2, and formed thinner than the anode substrate 2.

As a material of the cathode substrate 4, glass is preferably used, for example, because of the easiness of a forming process flow of the electron sources 3 and wiring 63 and because of consistency of its thermal expansion coefficient with that of the anode substrate 2. A silicon substrate and a metal plate such as kovar and 42 alloy, having an insulation layer on its surface, may be used. A material of a frame 5 is the same as that of the cathode 4.

The anode substrate 2 and cathode substrate 4 are bonded via the frame 5 so that the phosphors 1 and electron sources 3 are opposed to each other and in parallel with each other. The shape of the frame 5 is almost the same as the shape of the anode substrate 2. The cathode substrate 4 is formed rather larger than the shape of the frame 5. A space between the anode substrate 2 and cathode substrate 4 is formed as the electron emitting chamber 6 whose periphery is sealed by the frame 5. The electron emitting chamber 6 is evacuated. Electrons emitted from the electron sources 3 impinge upon the phosphors 1 so that the phosphors 1 emit light to display images.

Although the placement area of the electron sources is illustrated as one area because of the omission in FIG. 1, many electron sources 3 are actually arranged two-dimensionally. Although the placement area of the phosphors 1 is illustrated as one area because of the omission in FIG. 1, red phosphors, green phosphors, and blue phosphors are actually arranged two-dimensionally corresponding to the electron sources when a color panel is used.

A pressure support 74 includes a vacuum seal member 8 and a reinforcement member 7. The vacuum seal member 8 forms a pressure supporting chamber 8A vacuously sealed between itself and the cathode substrate 4 independently of the electron emitting chamber 6. The reinforcement member 7 is formed of a member having a gap, and sandwiched between the vacuum seal member 8 and cathode substrate 4 in the pressure supporting chamber 8A. At least both end portions of the reinforcement member 7 span the bonding area 23 for the cathode substrate 4 and anode substrate 2. The vacuum seal member 8 is formed of a flexible thin metal plate, and formed thinner and lighter than the cathode substrate 4. Since the pressure supporting chamber 8A is formed independently of the electron emitting chamber 6, gas, dust, and so on generated in the pressure supporting chamber 8A do not come into the electron emitting chamber 6.

The reinforcement member 7 having a gap in its inside is placed on the back of the electron source forming surface of the cathode substrate 4. The vacuum seal member 8 overlies the reinforcement member 7. A periphery of the vacuum seal member 8 is bonded to the cathode substrate 4. The inside of the reinforcement member 7 is evacuated. As a result, a pressure support 74 is formed. Accordingly, the reinforcement member 7 is pressed on the cathode substrate 4 to function as a core of the vacuum seal member 8.

In the field emission display panel 72, when the atmospheric pressure is directly applied to the cathode 4 due to the evacuation of the inside of the electron emitting chamber 6, the cathode substrate 4 flexes toward the inside of the electron emitting chamber 6. Accordingly, an appropriate space between the phosphors 1 and electron sources 3 cannot be maintained. When the cathode substrate 4 is thickened to decrease the flexing, for example a large panel over thirty-two inches is increased in weight to decrease its commercial value.

In this embodiment, since the vacuum seal member 8 forming the pressure supporting chamber 8A vacuously sealed between the vacuum seal member 8 and the cathode substrate 4, and the reinforcement member 7 which is formed of a member having a gap, which is sandwiched between the vacuum seal member 8 and cathode substrate 4 in the pressure supporting chamber 8A, and whose both end portions span the bonding area for the cathode substrate 4 and anode substrate 2, are provided, the cathode substrate 4 can be prevented from directly receiving the atmospheric pressure. The reinforcement member 7 is formed having gaps inside to have both a light weight and enough flexural rigidity to support the atmospheric pressure. Therefore, the flexing of the cathode substrate 4 is decreased even when the cathode substrate 4 is thin, so that high resolution, lightening, and thinning can be achieved.

Especially, in this embodiment, as the reinforcement member 7, a honeycomb structure, a rib structure, a porous body, a structure in which a plurality of fibers are laminated, or the like can be selected independently of the vacuum seal member 8. Accordingly, a structure and material which have a high flexural rigidity and are light can be selected as the reinforcement member 7, achieving high resolution, lightening, and thinning.

The periphery of the reinforcement member 7 is covered with the vacuum seal member 8. The inside of the reinforcement member 7 is evacuated to be pressed on the cathode substrate 4. In the assembling process of the field emission display panel, for example, heat may be generated in the production process due to, e.g., the heat when the anode substrate 2, cathode substrate 4, and the frame are bonded. In this embodiment, even when a thermal expansion coefficient difference between the reinforcement member 7 and cathode substrate 4 is large, slippage occurs between the reinforcement member 7 and cathode substrate 4 because the reinforcement member 7 is not bonded to the cathode substrate 4. Accordingly, the thermal stress due to the thermal expansion coefficient difference can be suppressed, and warp and destruction is hardly generated in the cathode substrate 4. Therefore, it is advantageous that a wide selection of a material for the reinforcement member 7 is possible.

The anode substrate 2 is exposed to the outside to show audiences the light emitted from the phosphors 1. Thus, it is not preferable that the pressure support 74 is placed on the front surface side of the anode substrate 2. As described in this embodiment, the cathode substrate 4, which does not affect on the appearance, is preferably lightened by use of the pressure support 74. Accordingly, the whole of the display panel can be lightened while maintaining the good appearance design. In light of the lightening, the cathode substrate is preferably thinner than the anode substrate, and can be remarkably thinned by providing the pressure support 74.

In the example shown in FIG. 3, to form the electron emitting chamber 6 between the anode substrate 2 and cathode substrate 4, the frame 5 which functions as a spacer is used between the planar anode substrate 2 and cathode substrate 4. As shown in FIG. 5, the anode substrate 2 may have a structure where a portion of the periphery of the anode substrate 2 integrally projects as a leg to be bonded to the cathode substrate 4. In this case, for example, a corner 2a of the periphery on the side of the electron emitting chamber 6 have a circular shape, so that a tensile stress intensively generated on an outer surface of the anode substrate 2 near the top of the corner 2a is eased. As a result, the structure becomes hard to collapse due to the evacuation.

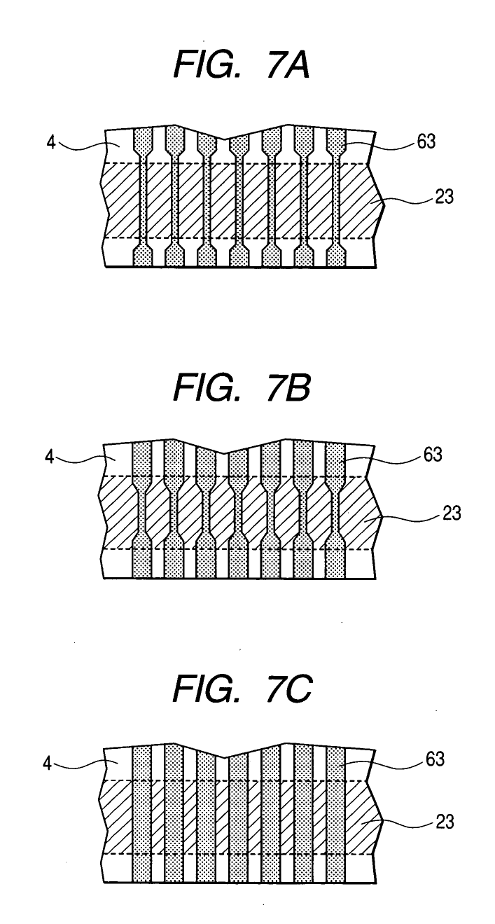

Next, a concrete structure of the cathode substrate 4 is explained with reference to FIGS. 6 and 7A to 7C. FIG. 6 is a perspective view showing a one quarter portion of the cathode substrate 4 in this embodiment. FIGS. 7A to 7C are enlarged plane views of a drawn portion of the wiring of FIG. 6.

Many scanning lines 21 and data lines 22 for controlling electrons emitted from the electron sources 3 are formed on the front surface (side of the electron emitting chamber 6) of the cathode substrate 4. The scanning lines 21 and data lines 22 need to be drawn to the outside of the electron emitting chamber 6 to be connected to a control unit 73 placed outside the display panel 72. The scanning lines 21 and data lines 22 are formed extending to the outside of the substrate bonding area 23, which is shown by dotted lines in FIG. 6 and is a bonding area of the cathode substrate 4 for the anode substrate 2, so that they are easily drawn. When the frame 5 shown in FIG. 3 is used, the substrate bonding area 23 is a bonding area for the cathode substrate 4 and frame 5. When the frame shown in FIG. 5 is not used, the substrate bonding area 23 is a bonding area where the cathode substrate 4 and anode substrate 2 are directly bonded to each other.

The scanning lines 21 and data lines 22 have been described as the wiring 63 in FIG. 2, and explained as the wiring 63 in FIGS. 7A to 7C. The frame 5 and cathode substrate 4 are bonded by use of, for example, solder glass. Solder glass in a paste form is applied to the substrate bonding area 23. The frame 5 is aligned with the substrate bonding area 23. Then, by firing the solder glass at about 400° C., the electron sources 3 and cathode substrate 4 can be bonded to each other.

The substrate bonding area 23 includes an area where the wiring 63 is placed (hereinafter called a wiring area) and an area where the surface of the cathode substrate 4 is exposed (hereinafter called a non-wiring area). The wiring 63 collectively means the scanning lines 21 and data lines 22. In the wiring area, adhesive forces between solder glass and the wiring 63 and between the wiring 63 and cathode substrate 4 may be lower than that of the non-wiring area. In this case, the wiring area is made smaller than the non-wiring area to increase a bonding strength of the substrate bonding area 23. The wiring area can be made smaller by thinning the wiring, but the thinning is limited in light of securing a current amount for driving the electron sources 3. As shown in the plane view of FIG. 7A, the wiring 63 is partially thinned in the area including the substrate bonding area 23, so that the wiring area can be made smaller than the wiring area where the wiring has an equal width shown in FIG. 7C, while suppressing the rise of the wiring resistance. When a problem about breakage of the wiring 63 at the end portion of the substrate bonding area 23 arises, the thinner portion of the wiring 63 is placed inside the end portion of the substrate bonding area 23 to secure the width of the wiring at the end portion, as shown in FIG. 7B. As a result, the wiring 63 can be hardly broken. Only the wiring around the end portion may be made wider than the usual wiring.

The number of the scanning lines 21 and data lines 22 is not limited to that shown in FIG. 6. The wiring may be drawn in the directions of all the four sides of the cathode substrate 4 or in the direction of the three or two sides. When the wiring is drawn in the three or two directions, the cost for the assembly and wiring can be reduced because the drawn portion is small. On the other hand, when the wiring is drawn in the four directions, the arrangement density can be decreased. As a result, the wiring area for one side becomes small to increase a strength of the bonding portion.

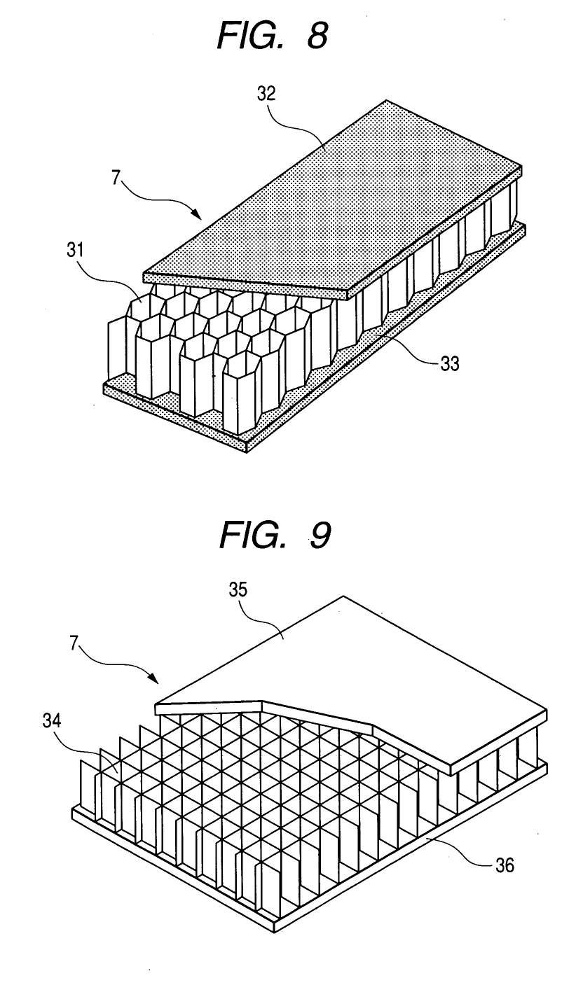

Next, the reinforcement member 7 is explained with reference to FIGS. 8 to 10.

The reinforcement member 7 is preferably formed of a structure and material which are light and have a high flexural rigidity, and can function by use of a honeycomb structure. A flexural rigidity of a plane is in proportion to a length in its parallel direction, and to the cube of its thickness. As shown in FIG. 8, by use of a structure having many flexed thin plates arranged in the thickness direction, the reinforcement member 7 which is light and has a high flexural rigidity can be obtained. This honeycomb structure is structured by bonding a honeycomb core 31 having a plurality of arranged thin plates to an upper surface plate 32 and lower surface plate 33. For easy understanding, the upper surface plate 32 is partially eliminated in FIG. 8. The upper surface plate 32 or lower surface plate 33 may be omitted. By bonding a plurality of the thin plates to each other, both of the upper surface plate and lower surface plate may be omitted.

The reinforcement member 7 is not limited to the structure shown in FIG. 8. The reinforcement member 7 may have any structure which is light and has a high flexural rigidity. For example, as shown in FIG. 9, a lib structure can be used which is structured by bonding a lib core 34 having a plurality of thin plates arranged in a grid to an upper surface plate 35 and lower surface plate 36. In this lib structure as well as in the honeycomb structure, the upper surface plate 35 or lower surface plate 36 or both may be omitted.

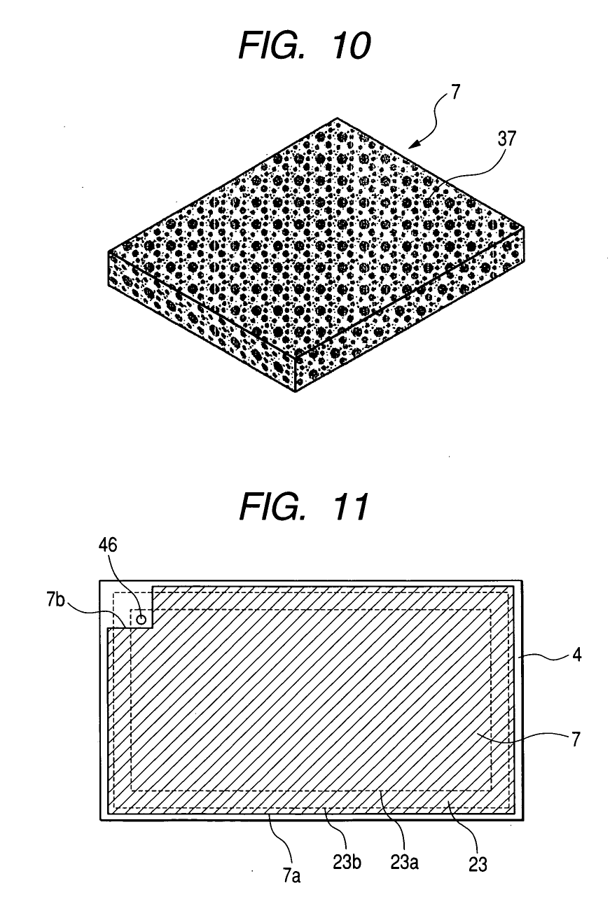

As shown in FIG. 10, the reinforcement member 7 may be structured by use of a light porous body 37 having many spaces in its inside.

Cloth fibers laminated to have a predetermined thickness may be used as the reinforcement member. For example, glass fiber may be used. The fiber it self has a small flexural rigidity. The cloth fibers are compressed by the atmospheric pressure, and then relative slippage of the cloth fibers is restrained. Therefore, vacuously sealed cloth fibers have a flexural rigidity. Further, since there are many spaces between the fibers, the lightening can be achieved, and the vacuum sealing is easily achieved. In this method, a reinforcement member having a large area can be easily produced at low cost by means of, for example, a weaving loom and non-woven fabric formation. Since the cloth fibers are flexible in the atmosphere, treatment of the reinforcement member in case of its installation is easy.

As described above, since the reinforcement member 7 is extremely lower in density than the cathode substrate 4 formed of, for example, glass, the cathode substrate 4 is preferably as thin as possible compared to the reinforcement member 7 in light of lightening as long as a flexural rigidity against the atmospheric pressure can be secured by both of the cathode substrate 4 and reinforcement member 7. At least, the cathode substrate 4 is preferably thinner than the reinforcement member 7.

The vacuum seal member 8 is placed covering the reinforcement member 7. The outer periphery of the vacuum seal member 8 is bonded to the cathode substrate 4. The inside of the vacuum seal member 8 including the inside of the reinforcement member 7 is evacuated, so that the surface of the vacuum seal member 8 receives the atmospheric pressure to press the whole of the reinforcement member 7 on the cathode substrate 4 equally. As a result, a local stress concentration can be prevented. Therefore, it is preferable that the vacuum seal member 7 is flexible, and has a thickness and material with which out-of-plane deformation is easily carried out. The vacuum seal member 7 needs a strength enough not to be broken due to the atmospheric pressure. For example, a thermal expansion coefficient of the vacuum seal member 8 is preferably near that of the cathode substrate 4 so that thermal deformation hardly occurs even when heat is generated in the bonding process for the frame 5 and cathode substrate 4. For example, a kovar thin plate and a metal thin plate such as 42 alloy, steel, copper, and aluminum may be used. Since a problem about the thermal deformation does not arise frequently when a rigidity of the vacuum seal member 8 is lower than that of the cathode substrate 4, a resin film having a high heat resistance, and so on can be used.

The inside of the reinforcement member 7 is evacuated by use of at least one evacuation port (not shown in figures) provided on the surface of the vacuum seal member 8. When the inside of the reinforcement member 7 is divided into closed cells between the vacuum seal member 8 and cathode substrate 4, it becomes difficult to evacuate the whole of the reinforcement member 7 from one portion. In this case, for example in the honeycomb structure shown in FIG. 8, a hole is formed to a side surface of each thin plate forming the honeycomb core 31 to remove the closed cells. As a result, the reinforcement member 7 is evacuated from its one portion. In the honeycomb structure, the thin plate can be bended by means of press die. In this case, the side hole can be simultaneously formed. Also in the rib structure shown in FIG. 9, by forming a hole on the side of each thin plate forming the rib core 34, the rib core 34 can be prevented from being divided into closed cells.

Next, relationship among the reinforcement member 7, cathode substrate 4, and evacuation port 46 is explained with reference to FIG. 11. FIG. 11 is a plane view showing a state that the cathode substrate 4 and reinforcement member 7 are laminated.

When the cathode substrate 4 directly receives the atmospheric pressure without the reinforcement member 7, bending moment due to the atmospheric pressure is intensively supported near an inside end portion of the substrate bonding area 23 of the cathode substrate 4. A high tensile stress is generated on an outer surface of the cathode substrate 4 near this end portion, and thus the cathode substrate 4 can be broken. In this embodiment, to prevent this breakage, at least both end portions of the reinforcement member 7 span the bonding area 23 for the cathode substrate 4 and anode substrate 2. In other words, at least both ends 7a are placed outside an inside end portion 23a of the substrate bonding area 23. In the example shown in FIG. 11, the cathode substrate 4 is rather smaller than the cathode substrate 4, and almost the same in shape (except a notched portion 45) as the cathode substrate 4. Four side ends of the reinforcement member 7 are placed almost on or rather outside an outside end portion 23b of the substrate bonding area 23. Therefore, the four side ends of the reinforcement member 7 substantially span the substrate bonding area 23, so that the reinforcement member 7 can be more certainly supported by the substrate bonding area 23. The end portions of the reinforcement member 7 extend to the outside of the outside end portion 23b, so that the reinforcement member 7 can be more certainly supported by the substrate bonding area 23.

To evacuate the electron emitting chamber 6, at least one evacuation port 46 can be provided to the anode substrate 2, frame 5, or cathode substrate 4. Since the evacuation port cannot be provided to the placement area of the phosphors 1 of the anode substrate 2 and the placement area of the electron sources 3 of the cathode 4 (both area are on the same picture plane, and hereinafter called an image display area), an evacuation port 46 is placed outside the image display area. To maintain the strength of the peripheries of the anode substrate 2 and frame 5, the evacuation port 46 is preferably provided to the cathode substrate 4. In this embodiment, as shown in FIG. 11, a notched portion 45 is formed on part of the reinforcement member 7 and vacuum seal member 8 on at least one of four corners of the display panel so that the cathode substrate 4 is exposed. Then, the evacuation port 46 is provided to an area inside the inside end portion 43 of the substrate bonding area 23 on the notched portion 45. In this case, a reinforcement end portion 42 is partially placed inside a substrate bonding area inside end portion 43. When most of the four ends of the reinforcement end portion 42 is placed on the bonding area 23 of the cathode substrate 4 and anode substrate 2, a problem about the strength does not arise.

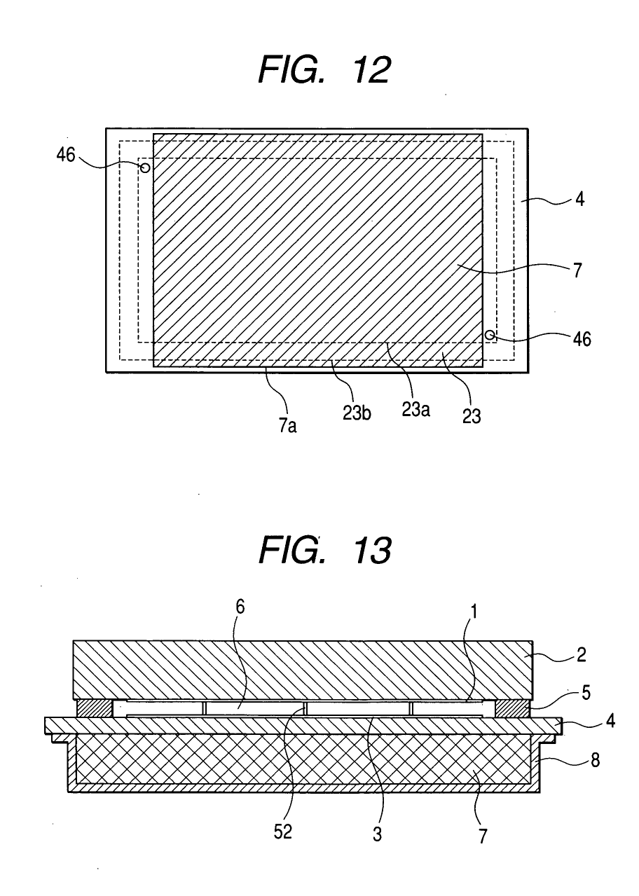

In a cross section in a short or long side direction of the display panel, as shown in FIG. 3, when both end portions of the reinforcement member 7 are placed outside the inside end portion 23a of the frame bonding area 23, a rigidity of the reinforcement member 7 can support the atmospheric pressure applied to the area of the reinforcement member 7. When the above condition is satisfied, the cathode substrate 4 can be prevented from being broken, because a stress does not concentrate near the inside end portion 23a of the frame bonding portion 23 of the cathode substrate 4 even when the end portion 7a of the reinforcement member 7 is placed inside the inside end portion 23a of the frame bonding area 23 on the opposing two sides as shown in the example of FIG. 12. In this case, the evacuation port 46 can be exposed while the shapes of the reinforcement member 7 and vacuum seal member 8 are simple. Since the evacuation port 46 can be exposed on a plurality of the opposite portions, the electron emitting chamber 6 can be evacuated efficiently, and a time for the evacuation can be shortened. Especially, in this embodiment, the evacuation ports 46 are provided diagonally, so that the evacuation time can be further shortened.

A vacuum inside the electron emitting chamber 6 is preferably a high vacuum of, for example, about 10⁻⁶ Torr so that the electron sources 3 emit electrons stably. On the other hand, a vacuum of the pressure supporting chamber 8A inside the vacuum seal member 8 may be enough to sufficiently press the reinforcement member 7 on the cathode substrate 4, and does not need to be high in light of shortening the production process. In other words, a vacuum of the electron emitting chamber 6 is preferably higher than a vacuum of the pressure supporting chamber 8A. Further, since the cathode substrate 4 receives a pressure corresponding to a pressure difference between the inside of the electron emitting chamber 6 and the inside of the pressure supporting chamber 8A, the pressure difference is set so that a rigidity of the cathode substrate 4 itself can resist the pressure difference.

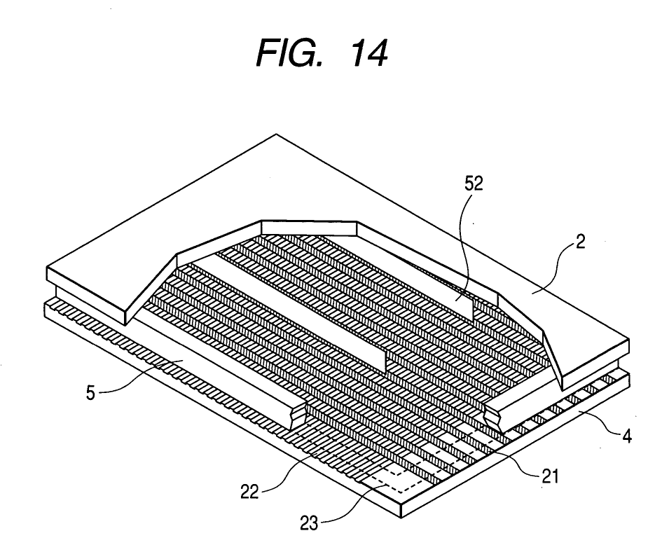

Next, a second embodiment of the present invention is explained with reference to FIGS. 13 and 14. FIG. 13 is a cross sectional view of the display panel 72 in the display apparatus of the second embodiment of the present invention. FIG. 14 is a perspective view of the display panel 72 which is partially cut. This second embodiment is different from the first embodiment in the after-mentioned points. In the other points, the second embodiment is basically the same as the first embodiment.

In this second embodiment, a small number of spacers 52 are placed between the anode substrate 2 and cathode substrate 4. Since the spacers 52 support the anode substrate 2 when the anode substrate 2 is pressed toward the inside of the electron emitting chamber 6 due to the atmospheric pressure, the anode substrate 2 flexes small even when the anode substrate 2 is thinned, and an appropriate space can be maintained between the phosphors 1 and electron sources 3. As a result, the anode substrate 2 is made thinner than in the first embodiment, so that the whole of the field emission display panel can be lightened.

The spacers 52 are preferably thinned to, for example, about 0.1 mm so that the spacers 52 are not noticeable when images are displayed. Not to crush pixels of the display, the spacers 52 are not placed on the electron sources 3 on the cathode substrate 4. For example, as shown in FIG. 15, the spacers 52 are preferably placed on the scanning lines 21.

1. A display apparatus including a thin display panel and a control unit for controlling the display panel,
the display panel comprising:
an anode substrate;
a cathode substrate which is placed opposite the anode substrate and forms an electron emitting chamber vacuously sealed between the cathode substrate and the anode substrate;
electron sources formed on an electron emitting chamber side of the cathode substrate;
phosphors which are formed on an electron emitting chamber side of the anode substrate and receive electron beam from the electron sources to emit light; and
a pressure support formed on a back of the electron emitting chamber side of the cathode substrate,
the pressure support comprising:
a vacuum seal member forming a pressure supporting chamber vacuously sealed between the vacuum seal member and the cathode substrate independently of the electron emitting chamber; and
a reinforcement member which is formed of a member having a gap, which is sandwiched between the vacuum seal member and the cathode substrate in the pressure supporting chamber, and at least both end portions of which span a bonding area of the cathode substrate for the anode substrate, and
the control unit controlling the electron sources.

2. The display apparatus according to claim 1 wherein the reinforcement member is structured by any one of a honeycomb structure, a lib structure, a porous body, and a structure where a plurality of cloth fibers are laminated.

3. The display apparatus according to claim 1 wherein the cathode substrate is formed thinner than the anode substrate, and the vacuum seal member is formed thinner and lighter than the cathode substrate.

4. The display apparatus according to claim 3 wherein the vacuum seal member is formed of a flexible metal thin plate.

5. The display apparatus according to claim 1 wherein the pressure supporting chamber is lower in vacuum than the electron emitting chamber.

6. The display apparatus according to claim 1 wherein the control unit is so structured that a substrate mounting an IC is placed on a planar surface of the vacuum seal member.

7. The display apparatus according to claim 1 wherein many wirings for driving the electron sources formed on the cathode substrate are provided, the wirings are drawn from the electron sources to an outside area of the electron emitting chamber, and the control unit is connected to a drawn portion of the wirings via a flexible wiring plate.

8. The display apparatus according to claim 7 wherein the wirings are partially made thin on a bonding area for the anode substrate and the cathode substrate.

9. The display apparatus according to claim 1 wherein the cathode substrate has an evacuation port for evacuating the electron emitting chamber, and the pressure support is placed on a portion except the evacuation port.

10. The display apparatus according to claim 9 wherein the cathode substrate is formed to be a quadrilateral, the evacuation port is provided on a corner of the cathode substrate, and the pressure support is so formed that a portion thereof corresponding to the evacuation port is notched.

11. A display module in which a thin display panel and a control unit for controlling the display panel are integrally combined,
the display panel comprising:
an anode substrate;
a cathode substrate which is formed opposite the anode substrate and forms an electron emitting chamber vacuously sealed between the cathode substrate and the anode substrate;
electron sources formed on an electron emitting chamber side of the cathode substrate;
phosphors which are formed on an electron emitting chamber side of the anode substrate and receive electron beam from the electron sources to emit light; and
a pressure support formed on a back of the electron emitting chamber side of the cathode substrate,
the pressure support comprising:
a vacuum seal member which forms a pressure supporting chamber vacuously sealed between the vacuum seal member and the cathode substrate independently of the electron emitting chamber; and
a reinforcement member which is formed of a member having a gap, which is sandwiched between the vacuum seal member and the cathode substrate in the pressure supporting chamber, and at least both end portions of which span a bonding area of the cathode substrate for the anode substrate, and
the control unit controlling the electron sources.

12. A display panel comprising:
an anode substrate;
a cathode substrate which is formed opposite the anode substrate and forms an electron emitting chamber vacuously sealed between the cathode substrate and the anode substrate;
electron sources formed on an electron emitting chamber side of the cathode substrate;
phosphors which are formed on an electron emitting chamber side of the anode substrate and receive electron beam from the electron sources to emit light; and
a pressure support formed on a back of the electron emitting chamber side of the cathode substrate,
the pressure support comprising:
a vacuum seal member which forms a pressure supporting chamber vacuously sealed between the vacuum seal member and the cathode substrate independently of the electron emitting chamber; and
a reinforcement member which is formed of a member having a gap, which is sandwiched between the vacuum seal member and the cathode substrate in the pressure supporting chamber, and at least both end portions of which span a bonding area of the cathode substrate for the anode substrate.

13. A display panel comprising:
an anode substrate;
a cathode substrate which is formed opposite the anode substrate and forms an electron emitting chamber vacuously sealed between the cathode substrate and the anode substrate;
electron sources formed on an electron emitting chamber side of the cathode substrate;
phosphors which are formed on an electron emitting chamber side of the anode substrate and receive electron beam from the electron sources to emit light; and
many wirings for driving the electron sources formed on the cathode substrate are provided, the wirings are drawn from the electron sources to an outside area of the electron emitting chamber, and the wirings are partially made thin on a bonding area for the anode substrate and the cathode substrate.
